(19) United States
(12) Patent Application Publication
(10) Pub. No.: US 2026/0052165 A1
(43) Pub. Date: Feb. 19, 2026

(54) SECURITY ANALYSIS OF DIVERSE IDENTITY PROVIDER AND SINGLE SIGN-ON CONFIGURATIONS

(71) Applicant: Beyond Identity Inc., New York, NY (US)

(72) Inventors: Colton Chojnacki, New York, NY (US); Jasson Casey, New York, NY (US); Allan Ziolkowski, New York, NY (US); Katarzyna Kumor, New York, NY (US); Jordan Webster, New York, NY (US); Crispin Cowan, New York, NY (US)

(21) Appl. No.: 18/887,715

(22) Filed: Sep. 17, 2024

Related U.S. Application Data
(60) Provisional application No. 63/684,306, filed on Aug. 16, 2024.

(51) Int. Cl. H04L 9/40

(52) U.S. Cl. CPC H04L 63/1433; H04L 63/10

(57) ABSTRACT

The present application relates to devices and components including apparatus, systems, and methods to perform risk analysis of authentication systems and presenting results of the risk analysis. The approaches can transform configuration data indicating authentication operations to a data format representation for performing risk analysis of the authentication systems.

### CROSS-REFERENCES TO RELATED APPLICATIONS

The present application claims the benefit of co-pending U.S. provisional applications Ser. No. 63/684,306, filed Aug. 16, 2024, entitled “Security Analysis of Diverse IDP and SSO Configurations,” the disclosure of which is incorporated by reference herein in its entirety.

### BACKGROUND

Computing systems have become targets of attacks from bad actors. One of the areas that has been a target of bad actors for accessing systems is user login credentials. In particular, many systems limit access of users and utilizes credentials provided by a user to determine whether the user is authorized to access the system. Bad actors can attempt to obtain credentials of users and utilize these credentials to access the system.

To provide additional security, additional approaches have developed for determining whether users are authorized for accessing systems. For example, the systems may obtain biometric data from users trying to access the systems and may determine whether the users are authorized for accessing the system based on the obtained biometric data. The systems may also be able to communicate with users requesting access by a different medium to determine whether the user is authorized to access the systems, such as by transmitting a text message, a phone call, an email, or other communication means seeking verification of the users' identities. These additional approaches for security can be used separately or in combination with one or more other authentication factors for determining whether requesting users are authorized for accessing the systems.

### BRIEF SUMMARY

In embodiments, a method for analyzing access authentication risk may include retrieving configuration data for access authentication for a system, and determining one or more authentication flows for accessing the system based at least in part on the configuration data. The method may further include determining one or more risk levels associated with the one or more authentication flows, and generating a risk representation illustrating at least a portion of the one or more risk levels associated with the one or more authentication flows.

In embodiments, a method for presenting a risk representation of access authentication for a system may include retrieving configuration data for access authentication for the system, and transforming the configuration data to a data format representation. The method may include generating the risk representation based at least in part on the data format representation, the risk representation illustrating one or more risk levels for authentication flows for accessing the system.

In embodiments, a method for analyzing one or more authentication operations for a system may include identifying configuration data indicating the one or more authentication operations, and determining one or more risk levels for the one or more authentication operations. The method may further include generating a risk representation that indicates the one or more risk levels for the one or more authentication operations.

### BRIEF DESCRIPTION OF THE DRAWINGS

FIG. 1 illustrates an example arrangement in accordance with some embodiments.

FIG. 2 illustrates an example risk representation diagram in accordance with some embodiments.

FIG. 3 illustrates an example risk representation table in accordance with some embodiments.

FIG. 4 illustrates an example risk representation diagram in accordance with some embodiments.

FIG. 5 illustrates an example comparative risk representation in accordance with some embodiments.

FIG. 6 illustrates an example procedure for generating a risk representation in accordance with some embodiments.

FIG. 7 illustrates an example procedure for generating a risk representation in accordance with some embodiments.

FIG. 8 illustrates an example procedure for generating a risk representation in accordance with some embodiments.

FIG. 9 shows a simplified block diagram of a representative computing system and client computing system usable to implement certain embodiments of the present design.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

Computer systems often utilize authentication products for authenticating users requesting access to the systems as part of determining whether the requesting users are authorized to access the systems. These authentication products may utilize one or more authentication factors for authenticating the users. Further, the authentication product may organize the authentication factors into one or more authentication flows for authenticating the users for accessing the systems. However, the authentication factors implemented by the authentication products present different risk levels for being improperly accessed and/or replicated by bad actors.

Limiting the risk levels of the authentication approaches of the authentication products can be extremely valuable to system administrators. Approaches and systems described herein can facilitate risk analysis of authentication flows of authentication products and identify weaknesses in the authentication flows. Additionally, the approaches and systems can facilitate changes to the authentication flows and/or changes to other authentication products to provide lower risks of improper authentication of users.

Identity Provider (IDP) and single sign-on (SSO) systems provide convenient and secure solutions to enterprises for users to authenticate to enterprise resources. For example, an enterprise may utilize an IDP and/or an SSO system or product to perform authentication for users attempting to sign in to a computer system of the enterprise. However, these systems also have complex configurability, and become insecure if misconfigured. Depending on the way the IDP and/or SSO system is configured, the system may provide a relatively high risk of improper user authentication, which can result in bad actors gaining access to the system of the enterprise.

This approach provides administrators with a security analysis of their current IDP and SSO configuration. The approaches read the configuration files for the IDP and SSO systems and analyzes them to find the weakest set of credentials that are sufficient to authenticate a user under the configuration at hand. It also performs dynamic analysis to identify authentication flows that are not being used, and therefore can be disabled to enhance overall system security.

For example, IDP and/or SSO systems may have configuration data that defines authentication operations performed by the systems for authenticating users. The systems described further herein may retrieve the configuration data and analyze the configuration data. The systems can determine the authentication operations of the IDP and/or SSO systems from the configuration data. Further, the systems may determine risk levels associated with the authentication operations and determine whether the risk levels meet a minimum target risk level.

The systems described further herein may further retrieve usage information from the IDP and/or SSO systems, such as usage statistics. The systems may determine which of the authentication operations are not being used for access based on the usage statistics. The systems may indicate which authentication operations are not being used for access. An administrator may request the systems to change the configuration data of the IDP and/or SSO systems to remove the unused authentication operations, or the administrator may alter the configuration data to remove the unused authentication operations. Removing the unused authentication operations may reduce the opportunities for bad actors to improperly access the systems, thereby providing better protection from bad actors.

The approaches may apply to diverse IDP and SSO solutions by way of abstracting the configuration details found in the system at hand and rendering them into a universal configuration format that is capable of expressing all pertinent information in the configuration across all IDP and SSO systems that it has been integrated with. For example, the systems described further throughout this disclosure may transform the configuration data from an IDP and/or SSO system to a universal data format representation. The systems may utilize the universal data format representation to analyze the risks of the IDP and/or SSO system and may generate a risk representation illustrating the risks of the IDP and/or SSO systems. The systems may further utilize the universal data format representation to generate other configuration data that can be utilized by another IDP and/or SSO system for performing user authentication.

Vulnerability scanners have existed for decades. However, these tools are tuned to detect vulnerabilities in the specific technologies they were designed for. The systems and approaches described herein may perform vulnerability scanning specifically against IDP and SSO configurations.

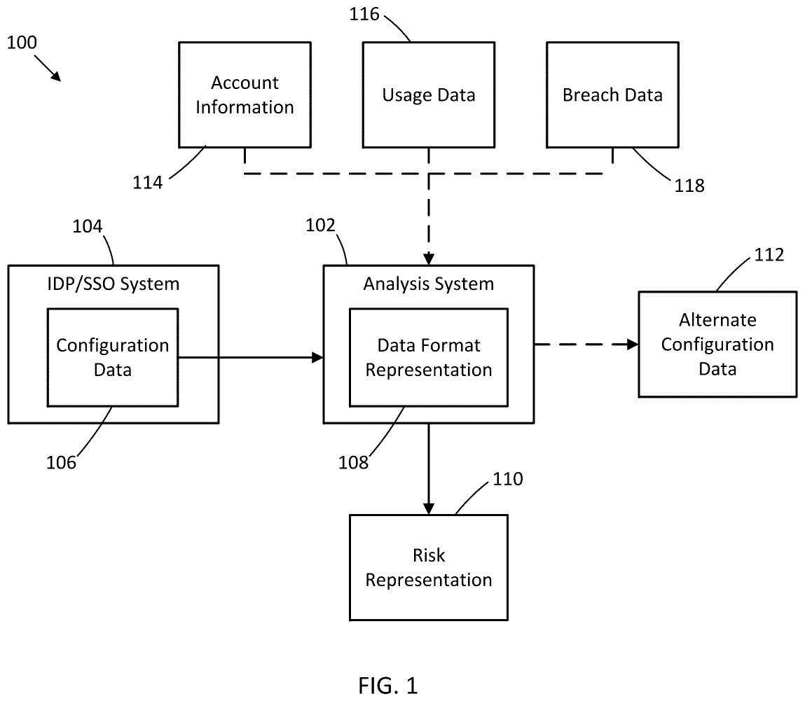

FIG. 1 illustrates an example arrangement 100 in accordance with some embodiments. The arrangement 100 illustrates an example of a system that can analyze risks of an IDP and/or SSO system and produce analysis outputs for the risks.

The arrangement 100 includes an analysis system 102. The analysis system 102 may implement one or more of the approaches described throughout this disclosure. For example, the analysis system 102 may perform risk analysis of IDP/SSO systems.

The arrangement 100 further includes an IDP/SSO system 104. The IDP/SSO system 104 may perform user authentication for access for one or more computer systems, such as enterprise computer systems. The IDP/SSO system 104 may part of a computer system for which the IDP/SSO system 104 performs authentication or separate from the computer system for which the IDP/SSO system 104 performs authentication.

The IDP/SSO system 104 may maintain configuration data for each computer system for which the IDP/SSO system 104 performs authentication. In the illustrated embodiment, the IDP/SSO system 104 maintains configuration data 106 for a computer system for which authentication is performed. The configuration data 106 may include an authentication configuration that defines authentication performed for the computer system. For example, the configuration data 106 may define authentication factors and/or authentication flows performed by the IDP/SSO system 104 for authenticating a user for access to the system.

The analysis system 102 may retrieve the configuration data 106 from the IDP/SSO system 104. The analysis system 102 may convert the configuration data 106 to a data format representation 108. The data format representation 108 may be a universal format to which configuration data of each IDP/SSO system can be converted. For example, the analysis system 102 may read the configuration data 106 and identify information related to authentication operations performed by the IDP/SSO system. The analysis system may identify characteristics of the configuration data 106 that indicates the information, such as usernames, passwords, contact information, locations, or other characteristics that indicate information related to authentication operations. The characteristics which the analysis system 102 utilizes for identifying the information related to the authentication operations may be pre-defined or may be determined via machine learning and/or artificial intelligence.

The analysis system 102 may perform risk analysis on the data format representation 108. The analysis system 102 may determine one or more authentication factors that can be performed for authentication from the data format representation 108. Further, the analysis system 102 may further determine one or more authentication flows into which the authentication factors are organized. For example, a system may provide multiple options of authentication flows, where each authentication flow includes one or more authentication factors. A user may select one of the authentication flows to access a system, where a user may be determined to be authenticated based on the one or more authentication factors being successfully completed. The authentication factors may include password authentication, identity provider (IdP) authentication, push authentication, time-based one-time password (TOTP) authentication, short message service authentication, and/or other approaches utilized for authenticating a user. The analysis system 102 may enumerate all the authentication flows and/or all of the authentication factors in the authentication flows.

The analysis system 102 may determine risk levels of the authentication flows and/or authentication factors. For example, the analysis system 102 may have defined risk levels for different authentication factors. The analysis system 102 may assign the corresponding risk levels to each of the identified authentication factors.

In some embodiments, the analysis system 102 may determine aggregate risk levels for each of the authentication flows based on the one or more authentication factors included in each of the authentication flows. For example, the analysis system 102 may determine an aggregate risk level for authentication flow based on the risk levels of the one or more authentication factors within the authentication flow. The aggregate risk level for the authentication flow may be determined to be a highest risk level of the authentication factors within the authentication flow, a lowest risk level of the authentication factors within the authentication flow, or an aggregate risk level based on some combination of the risk levels of the authentication factors within the authentication flow.

Further, the analysis system 102 may determine an aggregate risk level for the authentication defined by the configuration data 106 based on the one or more authentication flows. For example, the analysis system 102 may determine an aggregate risk level for the authentication based on the risk levels for the authentication factors and/or the aggregate risk levels for the authentication flows.

The analysis system 102 may generate a risk representation 110 that illustrates determined risk information based on the data format representation 108. For example, the risk representation 110 may indicate the one or more authentication factors, the one or more authentication flows, the one or more risk levels for the authentication factors, the one or more aggregated risk levels for the authentication flows, and/or the aggregated risk level for the configuration data. In some embodiments, the risk representation 110 may be a visual representation of the risk information. The risk representation 110 may be provided to an administrator system for display on the administrator system.

In some embodiments, the analysis system 102 may further generate alternate configuration data 112. The alternate configuration data 112 may correspond to another authentication product. The other authentication product may be a different IDP/SSO system or another authentication program. The alternate configuration data 112 may be implemented by the other authentication product to perform authentication for the computer system. The alternate configuration data 112 may present a lower risk than the configuration data 106. In some embodiments, the alternate configuration data 112 may be implemented by the IDP/SSO system 104 to perform authentication with a lower risk than by implementing the configuration data 106. The alternate configuration data 112 may facilitate migration to the other authentication product.

In some embodiments, the analysis system 102 may retrieve account information 114 for the computer system for which authentication is being performed. The account information may indicate accounts of one or more users that can access the computer system. The account information may further indicate information related to the accounts, such as the last time the account was used to access the computer system, grouping of the accounts, policy rules for the accounts, applications that can utilized by the accounts to access the computer system, keys (such as SSO application programming interface (API) keys) issued for the accounts, and/or session timers.

The analysis system 102 may determine resources that are no longer being used for accessing the computer system. For example, the analysis system 102 may determine that an account has not accessed the computer system within a threshold time based on the account information 114. Further, the analysis system 102 may determine that accounts within a group of accounts have not accessed the computer system within the threshold time based on the account information 114. The analysis system 102 may further determine policy rules and/or applications that have not been utilized for accessing the computer system within the threshold time. The risk representation 110 may indicate one or more of the resources that are no longer being used for accessing the computer system in some embodiments.

The analysis system 102 may determine inappropriate settings for the accounts based on the account information 114. For example, the analysis system 102 may determine that inactive SSO API keys may be utilized for accessing the computer system. Further, the analysis system 102 may determine that inappropriately session timers are set for the account. The risk representation 110 may indicate the inappropriate settings in some embodiments.

The analysis system 102 may further determine accounts that have authentication factor limitations. For example, some of the accounts may not be able to utilize some of the authentication factors for authentication. For example, an account may correspond to a printer that cannot utilize messaging authentication factors and biometric authentication factors (such as fingerprint authentication, facial authentication, and/or retina authentication) for authentication. These accounts may be referred to as machine accounts, which can be used for automation and services. The analysis system 102 may identify these accounts by inspecting directory information within the account information 114 for attributes associated with humans that machine accounts tend not to have, such as a personal phone number, a name of a manager, a salary, and/or other information that is not assigned to non-human resources. The machine accounts may be treated differently due to authentication factor limitations. For example, the analysis system 102 may avoid suggesting changes to the configuration data that cannot be supported by the machine accounts.

In some embodiments, the analysis system 102 may retrieve usage data 116 related to the configuration data 106. For example, the usage data 116 may provide usage information for the authentication flows and/or the authentication factors determined from the data format representation 108. The analysis system 102 determine whether any of the authentication flows and/or authentication factors have not been used within a threshold time. The analysis system 102 may indicate the authentication flows and/or authentication factors that have not been used within the threshold time. For example, the risk representation 110 may indicate the authentication flows and/or authentication factors that have not been used and may suggest disabling the authentication flows and/or authentication factors to enhance overall security.

In some embodiments, the analysis system 102 may retrieve breach data 118 related to authentication and/or authorization breaches. For example, the analysis system 102 may pull public breach-event data from sources that announce breaches. The analysis system 102 may determine authentication factors corresponding to the breach. If an authentication factor corresponding to the breach is a same authentication factor that is defined by the configuration data 106, the analysis system 102 may indicate the breach to an administrator. For example, the risk representation 110 may indicate a determined breach.

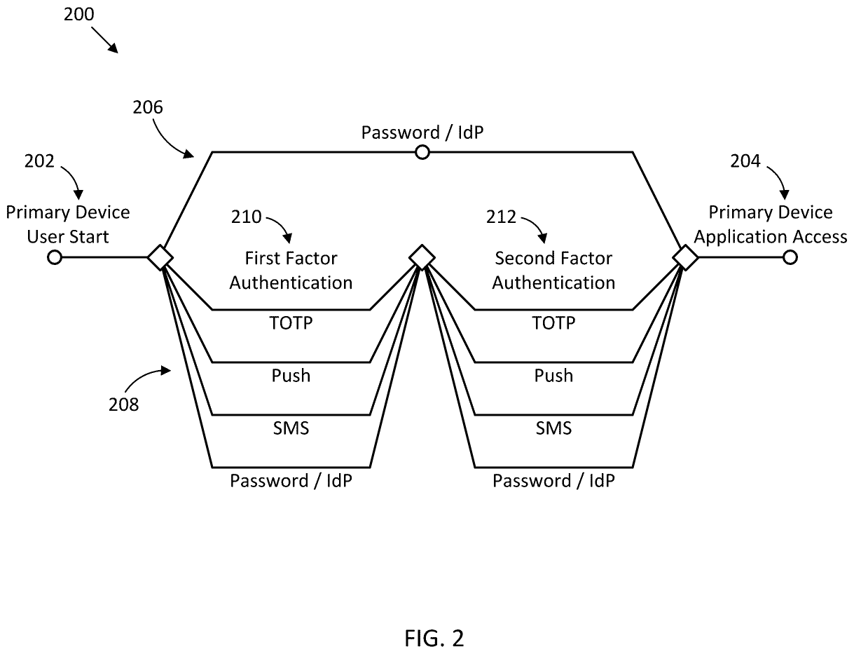

FIG. 2 illustrates an example risk representation diagram 200 in accordance with some embodiments. The diagram 200 may be part of a risk representation, such as the risk representation 110 (FIG. 1) generated by the analysis system 102 (FIG. 1). The diagram 200 illustrates authentication flows and authentication factors determined from configuration data, such as the configuration data 106 (FIG. 1). The diagram 200 illustrates a subway map of flows from an unauthenticated user to being authenticated.

The diagram 200 includes a primary device user start 202. The primary device user start 202 may indicate a point where a user requests access to a computer system. The diagram 200 further includes primary device application access 204. The primary device application access 204 illustrates a point where the user is provided access to the computer system. One or more authentication operations may be performed for the user to proceed from the primary device user start 202 to the primary device application access 204.

The diagram 200 may illustrate one or more authentication paths between the primary device user start 202 and the primary device application access 204. Further, the diagram 200 may illustrate one or more authentication factors along each of the authentication paths. In instances where an authentication path has different options for authentication factors that can be utilized within the authentication path, the diagram 200 may illustrate the different options for the authentication factors.

The diagram 200 illustrates a first authentication path 206. The first authentication path 206 may include a single authentication factor. In the illustrated embodiment, the first authentication path 206 includes a password/IdP authentication factor. The diagram 200 illustrates the first authentication path 206 as a line from the primary device user start 202 to the primary device application access 204. The first authentication path 206 may be a first option for authentication for accessing the computer system.

The diagram 200 illustrates a second authentication path 208. The second authentication path 208 may include a first factor authentication 210 and a second factor authentication 212, where each of the authentication factors need to be passed to provide access to the computer system. The second authentication path 208 may provide different authentication factors that can be used for the first factor authentication 210 and the second factor authentication 212. In the illustrated embodiment, a user may elect between a TOTP authentication factor, a push authentication factor, an SMS authentication factor, and a password/IdP authentication factor for the first factor authentication 210 and the second factor authentication 212. The user may be required to elect different authentication factors for each of the first factor authentication 210 and the second factor authentication 212.

The diagram 200 may order the options of the factor authentication in terms of risk levels in some embodiments. For example, the diagram 200 illustrates the order of the TOTP authentication factor, the push authentication factor, the SMS authentication factor, and the password/IDP authentication factor for each of the factor authentications based on the risk levels of each of the factors, the TOTP authentication factor having the lowest risk.

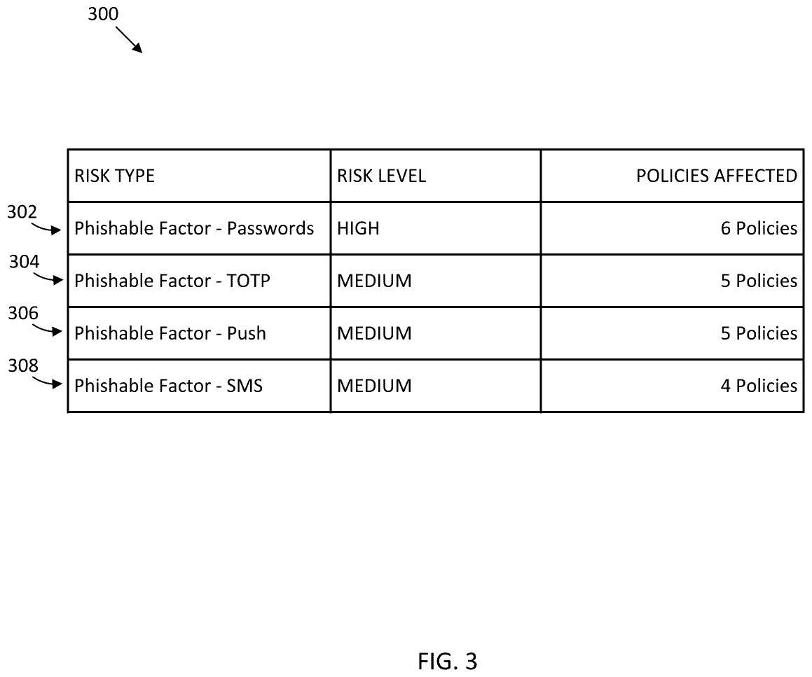

FIG. 3 illustrates an example risk representation table 300 in accordance with some embodiments. The table 300 may be part of a risk representation, such as the risk representation 110 (FIG. 1) generated by the analysis system 102 (FIG. 1). The table 300 may illustrate risks of authentication factors determined from configuration data, such as the configuration data 106 (FIG. 1). The table 300 may provide a summary of aggregate risks across analyzed policies.

The table 300 may indicate one or more authentication factors, the corresponding risk levels, and/or the policies affected by the authentication factors. In some embodiments, the table 300 may order the authentication factors by the corresponding risk level. In the illustrated embodiment, the table 300 illustrates a first authentication factor 302 of a passwords authentication factor. The table 300 indicates that the passwords authentication factor presents a high risk level and affects six policies.

Further, the table 300 illustrates a second authentication factor 304 of a TOTP authentication factor in the illustrated embodiment. The table 300 indicates that the TOTP authentication factor presents a medium risk and affects five policies.

Further, the table 300 illustrates a third authentication factor 306 of a push authentication factor in the illustrated embodiment. The table 300 indicates that the push authentication factor presents a medium risk and affects five policies.

Further, the table 300 illustrates a fourth authentication factor 308 of an SMS authentication factor in the illustrated embodiment. The table 300 indicates that the SMS authentication factor presents a medium risk and affects four policies.

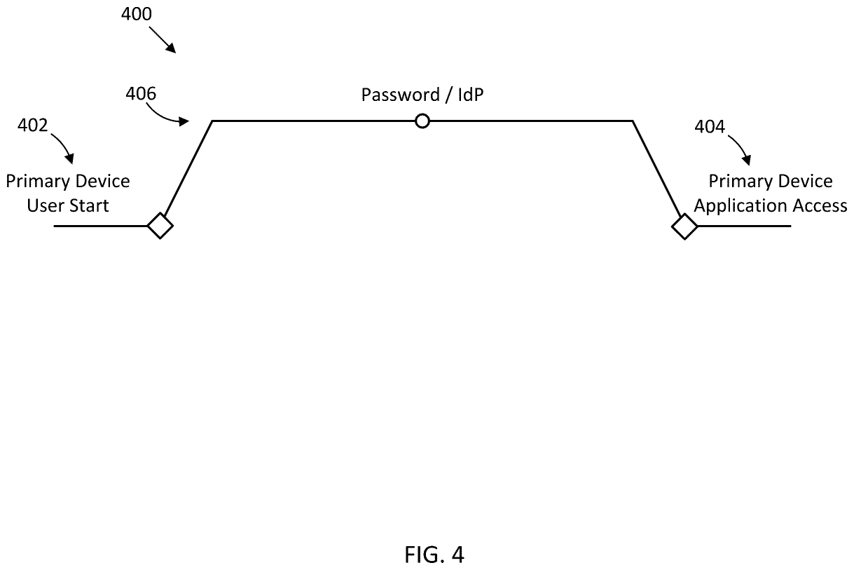

FIG. 4 illustrates an example risk representation diagram 400 in accordance with some embodiments. The diagram 400 may be part of a risk representation, such as the risk representation 110 (FIG. 1) generated by the analysis system 102 (FIG. 1). The diagram 400 illustrates authentication flows and authentication factors determined from configuration data, such as the configuration data 106 (FIG. 1). The diagram 200 illustrates a subway map of flows from an unauthenticated user to being authenticated.

The diagram 400 includes a primary device user start 402. The primary device user start 402 may indicate a point where a user requests access to a computer system. The diagram 400 further includes primary device application access 404. The primary device application access 404 illustrates a point where the user is provided access to the computer system. One or more authentication operations may be performed for the user to proceed from the primary device user start 402 to the primary device application access 404.

The diagram 400 may illustrate authentication paths with a single authentication factor. For example, the diagram 400 illustrates an authentication path 406 that includes a single authentication factor in the illustrated embodiment. In particular, the authentication path 406 includes a password/IdP authentication factor. The authentication path having a single factor may be higher risk, and/or may violate various multi-factor authentication (MFA) requirements. The authentication paths indicated by the diagram 400 may indicate authentication paths that should be updated to provide lower risk levels due to the single authentication factor.

It is common for an enterprise to have more that one SSO deployed at the same time. For example, two or more SSO products may be running in parallel for a system. Additionally, some large software as a service (SaaS) web applications have their own internal SSO functionality that effectively forms a custom mini-SSO running in parallel with the enterprise's SSO. Approaches described herein may perform scans across these multiple SSOs and integrates the results.

For example, any of the approaches described herein may be performed for one or more SSOs operating on a system. An analysis system (such as the analysis system 102 (FIG. 1)) may receive configuration data (such as the configuration data 106 (FIG. 1)) for more than one SSOs from a system and generate one or more data format representations (such as the data format representation 108 (FIG. 1)) for the more than one SSOs. In some embodiments, the one data representation may be generated for the more than one SSOs. In other embodiments, a data representation may be generated for each of the SSOs in more than one SSOs. The analysis system may generate a risk representation (such as the risk representation 110 (FIG. 1)) and/or one or more alternate configuration data (such as the alternate configuration data 112 (FIG. 1) based on the one or more data format representations.

To improve the latency of scans, only the SSOs that are of current interest may be scanned. For example, the analysis system may limit the SSOs that are currently being analyzed to SSOs that are of current interest. In some embodiments, a user may define SSOs that are of current interest, such as by allowing the user to select which SSOs the analysis system is to evaluate. In other embodiments, the analysis system may determine SSOs of current interest based on which SSOs that have been recently updated, which SSOs have been updated since the last analysis was performed on the SSO, which SSOs have been recently used, which SSOs have been used within a certain time period, a frequency of use of the SSOs, a recency within which the analysis was performed for the SSOs, an amount of users that utilize the SSOs to access the system, which of the SSOs were recently installed, or some combination thereof. The analysis system may utilize account information (such as the account information 114 (FIG. 1)), usage data (such as the usage data 116 (FIG. 1)), and/or breach data (such as the breach data 118 (FIG. 1)) to determine which of the SSOs are of current interest.

The analysis system may retrieve configuration data (such as the configuration data 106 (FIG. 1)) for all of the SSOs of a system or may retrieve configuration data for only the SSOs of a system that are of current interest. The analysis system may generate one or more data format representations (such as the data format representation 108 (FIG. 1)) for each of the SSOs that are of current interest. In instances where the analysis system retrieves configuration data for all of the SSOs of the system, the analysis system may identify the configuration data for the SSOs that are of current interest for generating the one or more data format representations. Limiting the generated data format representations to the SSOs of current interest may reduce the latency that would be caused by generating data format representations for all of the SSOs.

The analysis system may generate a risk representation (such as the risk representation 110 (FIG. 1)) and/or alternate configuration data (such as the alternate configuration data 112 (FIG. 1) for the SSOs of current interest based on the generated one or more data format representations. In some instances, the analysis system may also retrieve account information (such as the account information 114 (FIG. 1)), usage data (such as the usage data 116 (FIG. 1)), and/or breach data (such as the breach data 118 (FIG. 1)) related to the SSOs of current interest. The analysis system may additionally utilize the retrieved account information, the usage data, and/or the breach data to generate the risk representation for the SSOs of current interest.

When incrementally scanning additional SSOs, the new results are not just appended to the security report, they are integrated. For example, the same users may be represented in multiple SSOs, and the incremental scan may enhance or degrade the security ratings of each user, which is then represented as updated risk ratings in the report.

As an example, an analysis system (such as the analysis system 102 (FIG. 1)) may have already performed analysis of one or more SSOs. For example, the analysis system may have retrieved configuration data (such as configuration data 106 (FIG. 1)) for the one or more SSOs and generated one or more data format representations (such as the data format representation 108 (FIG. 1)) for the one or more SSOs. The analysis system may have already generated one or more risk representations (such as the risk representation 110 (FIG. 1)) and/or one or more alternate configuration data (such as the alternate configuration data 112 (FIG. 1)) based on the generated one or more data format representations.

The analysis system may perform analysis of one or more additional SSOs after the analysis of the previous SSOs has been completed. The analysis system may perform the analysis of the one or more additional SSOs in response to the one or more additional SSOs becoming of current interest after the analysis of the other one or more SSOs. The analysis system may retrieve the configuration data for the one or more additional SSOs. In some embodiments, the analysis system may update the one or more data format representations previously generated for the one or more SSOs based on the configuration data retrieved for the one or more additional SSOs. The analysis system may then utilize the updated one or more data format representations to generate an updated risk representation that incorporates both the one or more SSOs and the one or more additional SSOs. In other embodiments, the analysis system may generate one or more additional data format representations for the one or more additional SSOs and update the risk representation previously generated for the one or more SSOs based on the one or more additional data format representations. The analysis system may further update alternate configuration data based on the updated one or more data format representations and/or the additional one or more format representations.

The updates may be performed by integrating the additional configuration data from the one or more additional SSOs to generate the updated representations and/or configuration data. In instances where a user utilizes, or can utilize, the one or more SSOs that were previously analyzed and the one or more additional SSOs, information related to the user can be updated based on the analysis of the additional SSOs, including updating security ratings and/or risk ratings related to the user.

Analysis systems (such as the analysis system 102 (FIG. 1)) incorporating the approaches described herein can scan several kinds of SSOs. Some SSOs represent features that others do not. For example, Microsoft Entra SSO supports “privileged” accounts while Okta does not. The internal representation supports “privileged” accounts, and leaves that data blank when scanning Okta. In general, the analysis systems may support the union set of features supported by all SSO products that may be encountered, leaving unsupported features blank for specific scans.

For example, when the analysis system performs analysis of multiple SSOs, the analysis system may determine features that are supported by all of the multiple SSOs and features that are only supported by a portion of the multiple SSOs. In generating one or more data format representations (such as the data format representation 108 (FIG. 1)) and/or one or more risk representations (such as the risk representation 110 (FIG. 1)), the analysis system may integrate the features of the multiple SSOs. For the features that are supported by all of the multiple SSOs, the analysis system may utilize the values corresponding to the features for all of the multiple SSOs in integrating the features. For the features that are only supported by a portion of the multiple SSOs, the analysis system may utilize the values for the features from the SSOs that support the features and may leave the values for the features blank for the SSOs that do not support the features when generating the one or more data format representations and/or the one or more risk representations. In some embodiments, the one or more risk representations generated by the analysis system may indicate which SSOs support which features and/or which SSOs do not support certain features.

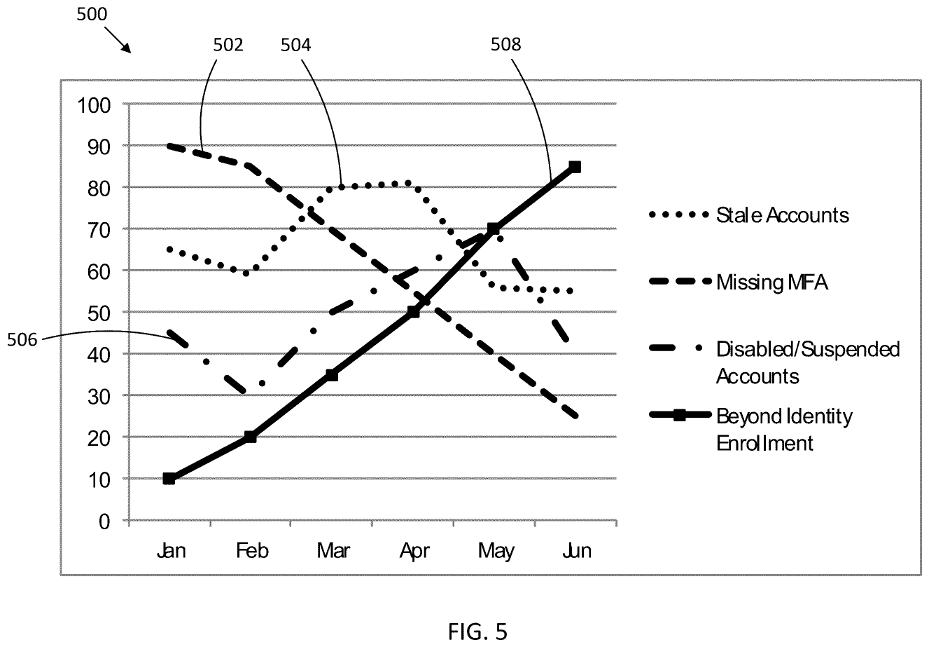

Analysis systems (such as the analysis system 102 (FIG. 1)) described herein may provide risk analysis over time to represent trends in risk factors and present reports as depicted in FIG. 5. For example, the analysis system may store data format representations (such as the data format representation 108 (FIG. 1)) for an SSO system (such as the IDP/SSO system 104 (FIG. 1)). The analysis system may analyze the SSO system at multiple different times. In some embodiments, the analysis system may be configured to analyze the SSO system at a specified time interval, such as weekly, monthly, and/or yearly. The analysis system may generate a data format representation each time that the SSO system is analyzed, and may store each of the generated data format representations associated with the times that each of the data format representations were generated.

The analysis system may generate a comparative risk representation, where the comparative risk representation illustrates information and/or differences between generated data format representations. FIG. 5 illustrates an example comparative risk representation 500 in accordance with some embodiments. The comparative risk representation 500 illustrates a comparison of characteristics of multiple data format representations generated at different times. In the illustrated embodiment, six data format representations are compared, the six data format representations being generated in January, February, March, April, May, and June, respectively. In the illustrated embodiment, the comparative risk representation 500 comprises a line graph with lines that indicate the values of some characteristics that are determined from the six data format representations.

The comparative risk representation 500 includes a missing multi-factor authentication (MFA) indication 502 in the illustrated embodiment. The missing MFA indication 502 may indicate a percentage of users of the SSO system that are not utilizing MFA at different times represented by the data format representations. For example, the analysis system may determine percentages of users not utilizing MFA at each of the times from the six data format representations. The analysis system may generate the comparative risk representation 500 with the missing MFA indication 502 indicating the percentages at the times corresponding to each of the six data format representations. Accordingly, the missing MFA indication 502 illustrates a trend in the percentage of users not utilizing MFA from January until February.

The comparative risk representation 500 includes a stale accounts indication 504 in the illustrated embodiment. The stale accounts indication 504 may indicate a percentage of stale accounts of the SSO system at different times represented by the data format representations, where the stale accounts may not have been utilized to access the SSO system in a certain amount of time. For example, the analysis system may determine percentages of stale accounts at each of the times from the six data format representations. The analysis system may generate the comparative risk representation 500 with the stale accounts indication 504 indicating the percentages at the times corresponding to each of the six data format representations. Accordingly, the stale accounts indication 504 illustrates a trend in the percentage of stale accounts from January until February.

The comparative risk representation 500 includes a disabled/suspended account indication 506 in the illustrated embodiment. The disabled/suspended account indication 506 may indicate a percentage of accounts of the SSO system that have been disabled and/or suspended accounts at different times represented by the data format representations. For example, the analysis system may determine percentages of disabled and/or suspended accounts at each of the times from the six data format representations. The analysis system may generate the comparative risk representation 500 with the disabled/suspended account indication 506 indicating the percentages at the times corresponding to each of the six data format representations. Accordingly, the disabled/suspended account indication 506 illustrates a trend in the percentage of disabled and/or suspended accounts from January until February.

The comparative risk representation 500 includes an enrollment indication 508 in the illustrated embodiment. The enrollment indication 508 may indicate a percentage of accounts of the SSO system enrolled in a service at different times represented by the data format representations. For example, the analysis system may determine percentages of enrolled accounts at each of the times from the six data format representations. The analysis system may generate the comparative risk representation 500 with the enrollment indication 508 indicating the percentages at the times corresponding to each of the six data format representations. Accordingly, the enrollment indication 508 illustrates a trend in the percentage of enrolled accounts from January until February.

There being multiple distinct risk factors across the enterprise, the analysis systems described herein can aggregate the multiple risk factors to create a total risk score, and depict the total risk score across time to show the total enterprise-wide trends. For example, an enterprise may utilize multiple SSO products. The analysis system may receive configuration data (such as the configuration data 106 (FIG. 1)) for each of the SSO products and generating one or more data format representations (such as the data format representation 108 (FIG. 1)) for the SSO products. The analysis system may aggregate risk factors from each of the one or more data format representations to generate a total risk score. In some instances, the analysis system generate a comparative risk representation (such as the comparative risk representation 500 (FIG. 5)) that illustrates total risk scores at different times to illustrate an enterprise-wide trend.

Aggregation of risk can use a variety of mathematical formulas, including average, geometric mean, and sum. For example, the analysis systems described herein can aggregate risk levels of an enterprise, of an SSO system (such as the IDP/SSO system 104 (FIG. 1)), of accounts of an SSO system, or some combination thereof. The analysis system may perform mathematical formulas with multiple determined risks to determine an aggregated risk. The mathematical formulas may include averaging, calculating a geometric mean, calculating a sum, or some combination thereof.

The SSO vulnerability scan results can be used as a sales tool to illustrate to potential customers the risks of their current configuration, and concomitant benefits of deploying a competing product. For example, the analysis systems described herein may generate a risk representation (such as the risk representation 110 (FIG. 1)) for current one or more SSO products implemented by a SSO system (such as the IDP/SSO system 104 (FIG. 1)) for display. The risk representation may be generated based on one or more data format representations (such as the data format representation 108 (FIG. 1)) generated from configuration data (such as the configuration data 106 (FIG. 1)) corresponding to the current one or more SSO products. The analysis system may further generate an alternate risk representation (such as the risk representation 110) from alternate configuration data (such as the alternate configuration data 112 (FIG. 1)) for presentation. The risk representation for the current one or more SSOs may be displayed with the alternate risk representation to illustrate how risk can be lowered by using an SSO product corresponding to the alternate configuration data.

The scanner can detect accounts that simultaneously have weak authentication requirements (e.g., MFA not mandated) and high privileges (such as IT Admin, or C-suite users) and thus pose even more elevated risk. For example, the analysis systems described herein can further determine privileges of one or more accounts. The analysis system may determine one or more accounts from account information (such as the account information 114 (FIG. 1)). The analysis system may further determine one or more privilege levels for the one or more accounts based on the account information. The analysis system may further determine risk levels associated with each of the accounts based on one or more data format representations (such as the data format representation 108 (FIG. 1)). The analysis system may determine accounts that have high privileges (e.g., privileges above a certain threshold privilege level) and that have high risk levels (e.g., risk levels above a certain threshold risk level). The analysis system may generate a risk representation (such as the risk representation 110 (FIG. 1)) that indicates the accounts determined to have high privileges and high risk levels.

The scanner can detect “stale” accounts; those that are still valid and can be logged into, but have not been used for a very long time. Such accounts can and should be disabled to reduce attack surface. For example, analysis systems described herein may identify accounts that have not been utilized for accessing a system within a threshold amount of time, which can be referred to as stale accounts. The analysis system may identify accounts from account information (such as the account information 114 (FIG. 1)). The analysis system may further determine last logins of the accounts from the account information and/or usage data (such as the usage data 116 (FIG. 1)). The analysis system may determine accounts that have not been used for accessing the system within a threshold time. The analysis system may generate a risk representation (such as the risk representation 110 (FIG. 1)) that indicates the stale accounts and/or suggests disabling the stale accounts.

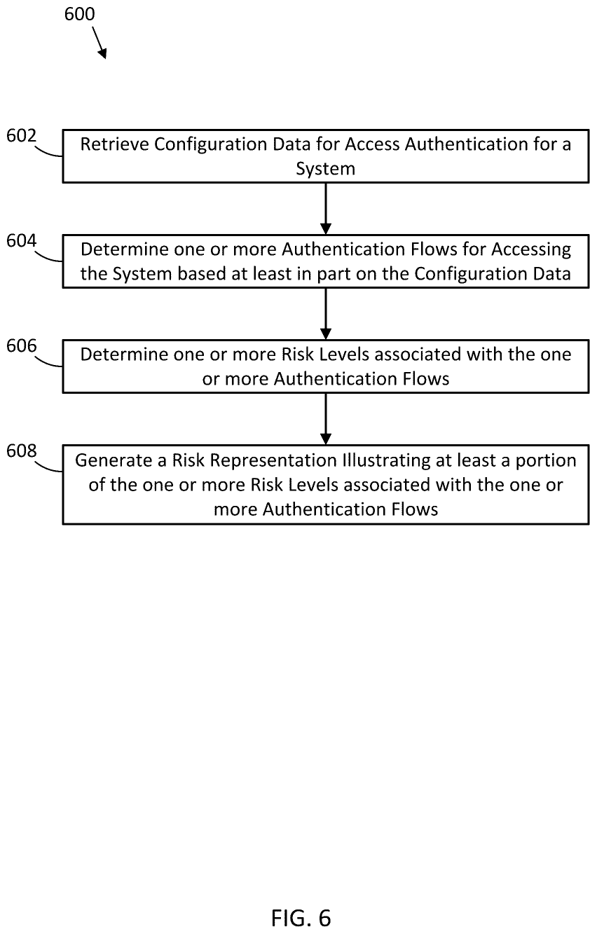

FIG. 6 illustrates an example procedure 600 for generating a risk representation in accordance with some embodiments. The procedure 600 may be performed by an analysis system, such as the analysis system 102 (FIG. 1).

The procedure 600 may include retrieving configuration data for access authentication for a system in 602.

The procedure 600 may include determining one or more authentication flows for accessing the system based at least in part on the configuration data in 604.

The procedure 600 may include determining one or more risk levels associated with the one or more authentication flows in 606.

In some embodiments, the procedure 600 may include transforming the configuration data to a data format representation for risk analysis. The one or more authentication flows and the one or more risk levels may be determined using the data format representation. In some of these embodiments, the configuration data may be first configuration data, wherein the first configuration data may correspond to a first authentication product. The procedure 600 may further include generating second configuration data based at least in part on the data format representation, the second configuration data corresponding to a second authentication product.

The procedure 600 may include generating a risk representation illustrating at least a portion of the one or more risk levels associated with the one or more authentication flows in 608.

In some embodiments, determining the one or more risk levels associated with the one or more authentication flows may include determining one or more risks levels for one or more authentication factors within the one or more authentication flows.

In embodiments, the procedure 600 may further include identifying an authentication flow from the one or more authentication flows, and determining a portion of the one or more authentication factors corresponding to the authentication flow. The procedure 600 may further include determining a portion of the one or more risk levels corresponding to the portion of the one or more authentication factors, wherein the risk representation includes a visual representation of the one or more authentication flows, and wherein the visual representation illustrates the authentication flow with the portion of the one or more authentication factors and the portion of the one or more risk levels with the portion of the one or more authentication factors.

In some embodiments, the procedure 600 may further include determining a portion of the one or more risk levels corresponding to an authentication flow of the one or more authentication flows, and generating an aggregate risk for the authentication flow based at least in part on the portion of the one or more risk levels, wherein the risk representation illustrates the aggregate risk for the authentication flow.

In some embodiments, the procedure 600 may include determining one or more authentication factors corresponding to the one or more authentication flows. The procedure 600 may further include determining usage statistics for the one or more authentication factors, wherein the risk representation indicates at least a portion of the usage statistics for the one or more authentication factors

In some embodiments, the procedure 600 may include determining a portion of the one or more authentication flows that include a single authentication factor, wherein the risk representation indicates the portion of the one or more authentication flows.

In some embodiments, the procedure 600 may include identifying breach event data. The procedure 600 may further include determining an authentication factor included in the one or more authentication flows corresponding to the breach event data, wherein the risk representation indicates the breach event data with the authentication factor.

In some embodiments, the procedure 600 may include retrieving account information associated with the system, and determining one or more accounts available to access the system based at least in part on the account information. The procedure 600 may further include determining access history for the one or more accounts based at least in part on the account information, and determining a portion of the one or more accounts have not accessed the system within a threshold amount of time, wherein the risk representation indicates the portion of the one or more accounts

In some embodiments, the procedure 600 may include retrieving account information associated with the system. The procedure 600 may further include determining one or more accounts with authentication factor limitation for accessing the system, wherein the risk representation indicates the one or more accounts with authentication factor limitation.

In some embodiments, the procedure 600 may include determining one or more access characteristics related to access provision for the system based at least in part on the configuration data. Further, the procedure 600 may include identifying a portion of the one or more access characteristics associated with high risk access activities, wherein the risk representation indicates the portion of the one or more access characteristics. In some of these embodiments, the high risk access activities include session timers that exceed a threshold time, or improper inactive key authentication.

While FIG. 6 may arguably imply an order of the operations of the procedure 600, it should be understood that one or more of the operations may be performed in a different order and/or one or more of the operations may be performed concurrently in embodiments. Further, it should be understood that one or more of the operations may be omitted from and/or one or more additional operations may be added to the procedure 600 in other embodiments.

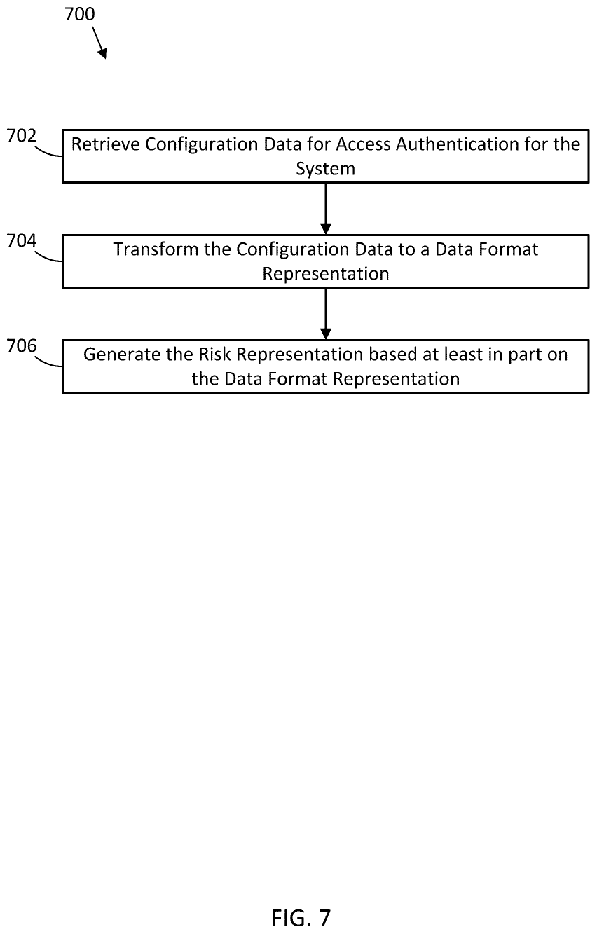

FIG. 7 illustrates an example procedure 700 for generating a risk representation in accordance with some embodiments. The procedure 700 may be performed by an analysis system, such as the analysis system 102 (FIG. 1).

The procedure 700 may include retrieving configuration data for access authentication for the system in 702.

The procedure 700 may include transforming the configuration data to a data format representation in 704.

The procedure 700 may include generating the risk representation based at least in part on the data format representation in 706. The risk representation may illustrate one or more risk levels for authentication flows for accessing the system.

In some embodiments, the configuration data may be first configuration data, wherein the first configuration data may correspond to a first authentication product, and wherein the one or more risk levels may be first one or more risk levels corresponding to the first authentication product. The procedure 700 may further include determining second one or more risk levels corresponding to a second authentication product available for the system, and generating second configuration data corresponding to the second authentication product based at least in part on the data format representation, the second configuration data to be utilized for access authentication for the system.

In some embodiments, the procedure 700 may include determining one or more authentication flows for the accessing the system. The procedure 700 may further include determining one or more aggregate risk levels for each of the one or more authentication flows, wherein the risk representation indicates the one or more aggregate risk levels for each of the one or more authentication flows.

In some embodiments, the procedure 700 may include determining a first authentication factor associated with an authentication flow for accessing the system, and determining a second authentication factor associated with the authentication flow. The procedure 700 may further include determining a first risk level for the first authentication factor, and determining a second risk level for the second authentication factor, wherein the risk representation indicates the authentication flow with first risk level indicated with the first authentication factor and the second risk level indicated with the second authentication factor

While FIG. 7 may arguably imply an order of the operations of the procedure 700, it should be understood that one or more of the operations may be performed in a different order and/or one or more of the operations may be performed concurrently in embodiments. Further, it should be understood that one or more of the operations may be omitted from and/or one or more additional operations may be added to the procedure 700 in other embodiments.

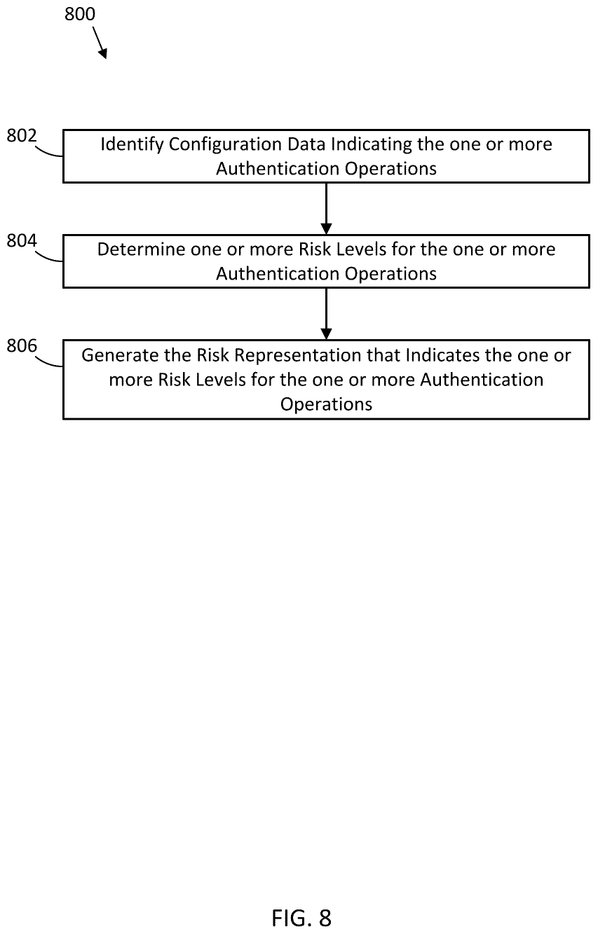

FIG. 8 illustrates an example procedure 800 for generating a risk representation in accordance with some embodiments. The procedure 800 may be performed by an analysis system, such as the analysis system 102 (FIG. 1).

The procedure 800 may include identifying configuration data indicating the one or more authentication operations in 802.

The procedure 800 may include determining one or more risk levels for the one or more authentication operations in 804.

In some embodiments, the procedure 800 may include generating a risk representation that indicates the one or more risk levels for the one or more authentication operations in 806.

In some embodiments, the procedure 800 may include transforming the configuration data to a data format representation. The procedure 800 may further include determining the one or more authentication operations based at least in part on the data format representation, the one or more authentication operations including one or more authentication factors.

In some embodiments, the procedure 800 may include determining one or more authentication flows for accessing the system. The procedure 800 may further include determining one or more aggregate risk levels for the one or more authentication flows based at least in part on the one or more risk levels for the one or more authentication operations, wherein the risk representation indicates the one or more authentication flows with the one or more aggregate risk levels.

While FIG. 8 may arguably imply an order of the operations of the procedure 800, it should be understood that one or more of the operations may be performed in a different order and/or one or more of the operations may be performed concurrently in embodiments. Further, it should be understood that one or more of the operations may be omitted from and/or one or more additional operations may be added to the procedure 800 in other embodiments.

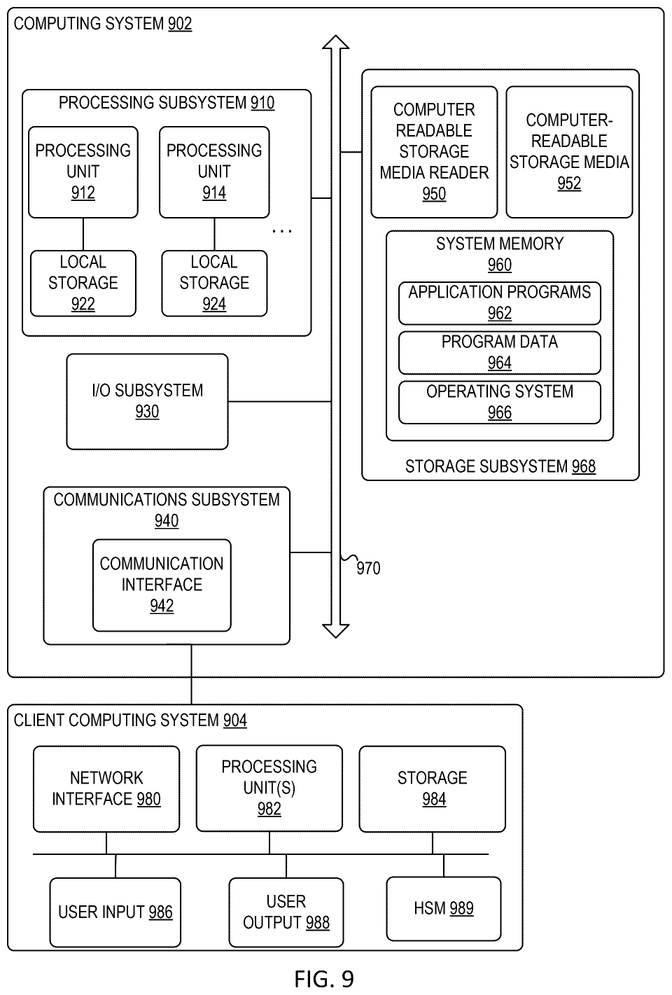

Various operations described herein may be implemented on computer systems. FIG. 9 shows a simplified block diagram of a representative computing system 902 and client computing system 904 usable to implement certain embodiments of the present design. In various embodiments, computing system 902 or similar systems may implement the server or website computing system or other verifying party, or any other computing system described herein or portions thereof. Client computing system 904 or similar systems may implement user devices such as a smartphone, tablet, computer, smart watch, or other devices.

Computing system 902 may be one of various types, including processor and memory, a handheld portable device (e.g., an iPhone® cellular phone, an iPad® computing tablet, a PDA), a wearable device (e.g., a Google Glass® head mounted display), a personal computer, a workstation, a mainframe, a kiosk, a server rack, or any other data processing system.

Computing system 902 may include processing subsystem 910. Processing subsystem 910 may communicate with a number of peripheral systems via bus subsystem 970. These peripheral systems may include I/O subsystem 930, storage subsystem 968, and communications subsystem 940.

Bus subsystem 970 provides a mechanism for letting the various components and subsystems of server computing system 904 communicate with each other as intended. Although bus subsystem 970 is shown schematically as a single bus, alternative embodiments of the bus subsystem may utilize multiple buses. Bus subsystem 970 may form a local area network that supports communication in processing subsystem 910 and other components of server computing system 902. Bus subsystem 970 may be implemented using various technologies including server racks, hubs, routers, etc. Bus subsystem 970 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which may be implemented as a Mezzanine bus manufactured to the IEEE P1386.1 standard, and the like.

I/O subsystem 930 may include devices and mechanisms for inputting information to computing system 902 and/or for outputting information from or via computing system 902. In general, use of the term “input device” is intended to include all possible types of devices and mechanisms for inputting information to computing system 902. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments, and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computing system 902 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Processing subsystem 910 controls the operation of computing system 902 and may comprise one or more processing units 912, 914, etc. A processing unit may include one or more processors, including single core processor or multicore processors, one or more cores of processors, or combinations thereof. In some embodiments, processing subsystem 910 may include one or more special purpose co-processors such as graphics processors, digital signal processors (DSPs), or the like. In some embodiments, some or all of the processing units of processing subsystem 910 may be implemented using customized circuits, such as application specific integrated circuits (ASICs), or field programmable gate arrays (FPGAs). In some embodiments, such integrated circuits execute instructions that are stored on the circuit itself. In other embodiments, processing unit(s) may execute instructions stored in local storage, e.g., local storage 922, 924. Any type of processors in any combination may be included in processing unit(s) 912, 914.

In some embodiments, processing subsystem 910 may be implemented in a modular design that incorporates any number of modules (e.g., blades in a blade server implementation). Each module may include processing unit(s) and local storage. For example, processing subsystem 910 may include processing unit 912 and corresponding local storage 922, and processing unit 914 and corresponding local storage 924.

Local storage 922, 924 may include volatile storage media (e.g., conventional DRAM, SRAM, SDRAM, or the like) and/or nonvolatile storage media (e.g., magnetic or optical disk, flash memory, or the like). Storage media incorporated in local storage 922, 924 may be fixed, removable or upgradeable as desired. Local storage 922, 924 may be physically or logically divided into various subunits such as a system memory, a ROM, and a permanent storage device. The system memory may be a read and write memory device or a volatile read and write memory, such as dynamic random-access memory. The system memory may store some or all of the instructions and data that processing unit(s) 912, 914 need at runtime. The ROM may store static data and instructions that are needed by processing unit(s) 912, 914. The permanent storage device may be a nonvolatile read and write memory device that may store instructions and data even when a module including one or more processing units 912, 914 and local storage 922, 924 is powered down. The term “storage medium” as used herein includes any medium in which data may be stored indefinitely (subject to overwriting, electrical disturbance, power loss, or the like) and does not include carrier waves and transitory electronic signals propagating wirelessly or over wired connections.

In some embodiments, local storage 922, 924 may store one or more software programs to be executed by processing unit(s) 912, 914, such as an operating system and/or programs implementing various server functions. “Software” refers generally to sequences of instructions that, when executed by processing unit(s) 912, 914 cause computing system 902 (or portions thereof) to perform various operations, thus defining one or more specific machine implementations that execute and perform the operations of the software programs. The instructions may be stored as firmware residing in read only memory and/or program code stored in nonvolatile storage media that may be read into volatile working memory for execution by processing unit(s) 912, 914. In some embodiments the instructions may be stored by storage subsystem 968 (e.g., computer readable storage media). In various embodiments, the processing units may execute a variety of programs or code instructions and may maintain multiple concurrently executing programs or processes. At any given time, some or all of the program code to be executed may be resident in local storage 922, 924 and/or in storage subsystem including potentially on one or more storage devices. Software may be implemented as a single program or a collection of separate programs or program modules that interact as desired. From local storage 922, 924 (or nonlocal storage described below), processing unit(s) 912, 914 may retrieve program instructions to execute and data to process in order to execute various operations described above.

Storage subsystem 968 provides a repository or data store for storing information that is used by computing system 902. Storage subsystem 968 provides a tangible non-transitory computer-readable storage medium for storing the basic programming and data constructs that provide the functionality of some embodiments. Software (programs, code modules, instructions) that when executed by processing subsystem 910 provide the functionality described above may be stored in storage subsystem 968. The software may be executed by one or more processing units of processing subsystem 910. Storage subsystem 968 may also provide a repository for storing data used in accordance with the present design.

Storage subsystem 968 may include one or more non-transitory memory devices, including volatile and non-volatile memory devices. As shown in FIG. 9, storage subsystem 968 includes a system memory 960 and a computer-readable storage media 952. System memory 960 may include a number of memories including a volatile main RAM for storage of instructions and data during program execution and a non-volatile ROM or flash memory in which fixed instructions are stored. In some implementations, a basic input/output system (BIOS), containing the basic routines that help to transfer information between elements within computing system 902, such as during start-up, may typically be stored in the ROM. The RAM typically contains data and/or program modules that are presently being operated and executed by processing subsystem 910. In some implementations, system memory 960 may include multiple different types of memory, such as static random-access memory (SRAM) or dynamic random-access memory (DRAM). Storage subsystem 968 may be based on magnetic, optical, semiconductor, or other data storage media. Direct attached storage, storage area networks, network attached storage, and the like may be used. Any data stores or other collections of data described herein as being produced, consumed, or maintained by a service or server may be stored in storage subsystem 968.

By way of example, and not limitation, as depicted in FIG. 9, system memory 960 may store application programs 962, which may include client applications, Web browsers, mid-tier applications, relational database management systems (RDBMS), etc., program data 964, and one or more operating systems 966. By way of example, an example operating systems may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Computer-readable storage media 952 may store programming and data constructs that provide the functionality of some embodiments. Software (programs, code modules, instructions) that when executed by processing subsystem 910 a processor provide the functionality described above may be stored in storage subsystem 968. By way of example, computer-readable storage media 952 may include non-volatile memory such as a hard disk drive, a magnetic disk drive, an optical disk drive such as a CD ROM, DVD, a Blu-Ray® disk, or other optical media. Computer-readable storage media 952 may include, but is not limited to, Zip® drives, flash memory cards, universal serial bus (USB) flash drives, secure digital (SD) cards, DVD disks, digital video tape, and the like. Computer-readable storage media 952 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. Computer-readable media 952 may provide storage of computer-readable instructions, data structures, program modules, and other data for computing system 902.

In certain embodiments, storage subsystem 968 may also include a computer-readable storage media reader 950 that may further be connected to computer-readable storage media 952. Together and, optionally, in combination with system memory 960, computer-readable storage media 952 may comprehensively represent remote, local, fixed, and/or removable storage devices plus storage media for storing computer-readable information.

In certain embodiments, computing system 902 may provide support for executing one or more virtual machines. Computing system 902 may execute a program such as a hypervisor for facilitating the configuring and managing of the virtual machines. Each virtual machine may be allocated memory, compute (e.g., processors, cores), I/O, and networking resources. Each virtual machine typically runs its own operating system, which may be the same as or different from the operating systems executed by other virtual machines executed by computing system 902. Accordingly, multiple operating systems may potentially be run concurrently by computing system 902. Each virtual machine generally runs independently of the other virtual machines.

Communication subsystem 940 provides an interface to other computer systems and networks. Communication subsystem 940 serves as an interface for receiving data from and transmitting data to other systems from computing system 902. For example, communication subsystem 940 may enable computing system 902 to establish a communication channel to one or more client computing devices via the Internet for receiving and sending information from and to the client computing devices.

Communication subsystem 940 may support both wired and/or wireless communication protocols. For example, in certain embodiments, communication subsystem 940 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 902.11 family standards, or other mobile communication technologies, or any combination thereof), global positioning system (GPS) receiver components, and/or other components. In some embodiments communication subsystem 940 may provide wired network connectivity (e.g., Ethernet) in addition to or instead of a wireless interface.

Communication subsystem 940 may receive and transmit data in various forms. For example, in some embodiments, communication subsystem 940 may receive input communication in the form of structured and/or unstructured data feeds, event streams, event updates, and the like. For example, communication subsystem 940 may be configured to receive (or send) data feeds in real-time from users of social media networks and/or other communication services such as Twitter® feeds, Facebook® updates, web feeds such as Rich Site Summary (RSS) feeds, and/or real-time updates from one or more third party information sources.

In certain embodiments, communication subsystem 940 may be configured to receive data in the form of continuous data streams, which may include event streams of real-time events and/or event updates, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communication subsystem 940 may also be configured to output the structured and/or unstructured data feeds, event streams, event updates, and the like to one or more databases that may be in communication with one or more streaming data source computers coupled to computing system 902.

Communication subsystem 940 may provide a communication interface 942, e.g., a WAN interface, which may provide data communication capability between the local area network (bus subsystem 970) and a larger network, such as the Internet. Conventional or other communications technologies may be used, including wired (e.g., Ethernet, IEEE 902.3 standards) and/or wireless technologies (e.g., WiFi, IEEE 902.11 standards).

Computing system 902 may operate in response to requests received via communication interface 942. Further, in some embodiments, communication interface 942 may connect computing systems 902 to each other, providing scalable systems capable of managing high volumes of activity. Conventional or other techniques for managing server systems and server farms (collections of server systems that cooperate) may be used, including dynamic resource allocation and reallocation.

Computing system 902 may interact with various user owned or user operated devices via a wide area network such as the Internet. An example of a user operated device is shown in FIG. 9 as client computing system 902. Client computing system 904 may be implemented, for example, as a consumer device such as a smart phone, other mobile phone, tablet computer, wearable computing device (e.g., smart watch, eyeglasses), desktop computer, laptop computer, and so on.

For example, client computing system 904 may communicate with computing system 902 via communication interface 942. Client computing system 904 may include conventional computer components such as processing unit(s) 982, storage device 984, network interface 980, user input device 986, and user output device 988. Client computing system 904 also includes a Hardware Security Module (HSM) 989, which can include the TPMs described above. Client computing system 904 may be a computing device implemented in a variety of form factors, such as a desktop computer, laptop computer, tablet computer, smart phone, other mobile computing device, wearable computing device, or the like.

Processing unit(s) 982 and storage device 984 may be similar to processing unit(s) 912, 914 and local storage 922, 924 described above. Suitable devices may be selected based on the demands to be placed on client computing system 904; for example, client computing system 904 may be implemented as a “thin” client with limited processing capability or as a high-powered computing device. Client computing system 904 may be provisioned with program code executable by processing unit(s) 982 to enable various interactions with computing system 902 of a message management service such as accessing messages, performing actions on messages, and other interactions described above. Some client computing systems 904 may also interact with a messaging service independently of the message management service.

Network interface 980 may provide a connection to a wide area network (e.g., the Internet) to which communication interface 942 of computing system 902 is also connected. In various embodiments, network interface 980 may include a wired interface (e.g., Ethernet) and/or a wireless interface implementing various RF data communication standards such as WiFi, Bluetooth®, or cellular data network standards (e.g., 3G, 4G, LTE, etc.).

User input device 986 may include any device (or devices) via which a user may provide signals to client computing system 904; client computing system 904 may interpret the signals as indicative of particular user requests or information. In various embodiments, user input device 986 may include any or all of a keyboard, touch pad, touch screen, mouse or other pointing device, scroll wheel, click wheel, dial, button, switch, keypad, microphone, and so on.

User output device 988 may include any device via which client computing system 904 may provide information to a user. For example, user output device 988 may include a display to display images generated by or delivered to client computing system 904. The display may incorporate various image generation technologies, e.g., a liquid crystal display (LCD), light emitting diode (LED) including organic light emitting diodes (OLED), projection system, cathode ray tube (CRT), or the like, together with supporting electronics (e.g., digital to analog or analog to digital converters, signal processors, or the like). Some embodiments may include a device such as a touchscreen that function as both input and output device. In some embodiments, other user output devices 988 may be provided in addition to or instead of a display. Examples include indicator lights, speakers, tactile “display” devices, printers, and so on.

Some embodiments include electronic components, such as microprocessors, storage and memory that store computer program instructions in a computer readable storage medium. Many of the features described in this specification may be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher level code that are executed by a computer, an electronic component, or a microprocessor using an interpreter. Through suitable programming, processing unit(s) 912, 914 and 982 may provide various functionality for computing system 902 and client computing system 904, including any of the functionality described herein as being performed by a server or client, or other functionality associated with message management services.

It will be appreciated that computing system 902 and client computing system 904 are illustrative and that variations and modifications are possible. Computer systems used in connection with embodiments of the present design may have other capabilities not specifically described here. Further, while computing system 902 and client computing system 904 are described with reference to particular blocks, it is to be understood that these blocks are defined for convenience of description and are not intended to imply a particular physical arrangement of component parts. For instance, different blocks may be but need not be located in the same facility, in the same server rack, or on the same motherboard. Further, the blocks need not correspond to physically distinct components. Blocks may be configured to perform various operations, e.g., by programming a processor or providing appropriate control circuitry, and various blocks might or might not be reconfigurable depending on how the initial configuration is obtained. Embodiments of the present design may be realized in a variety of apparatus including electronic devices implemented using any combination of circuitry and software.

While the design has been described with respect to specific embodiments, one skilled in the art will recognize that numerous modifications are possible. Embodiments of the design may be realized using a variety of computer systems and communication technologies including but not limited to specific examples described herein.

Embodiments of the present design may be realized using any combination of dedicated components and/or programmable processors and/or other programmable devices. The various processes described herein may be implemented on the same processor or different processors in any combination. Where components are described as being configured to perform certain operations, such configuration may be accomplished, e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present design may be encoded and stored on various computer readable storage media; suitable media include magnetic disk or tape, optical storage media such as compact disk (CD) or DVD (digital versatile disk), flash memory, and other non-transitory media. Computer readable media encoded with the program code may be packaged with a compatible electronic device, or the program code may be provided separately from electronic devices (e.g., via Internet download or as a separately packaged computer readable storage medium).

Thus, although the design has been described with respect to specific embodiments, it will be appreciated that the design is intended to cover all modifications and equivalents within the scope of the following claims.

### EXAMPLES

In the following sections, further exemplary embodiments are provided.
Example 1 may include to read diverse IDP and SSO configuration data and transform it into a single representation so that analysis can be performed on a single data format.
Example 2 may include to use the abstract representation to re-emit policy in a different IDP and SSO configuration format, to facilitate migration from one brand of product to another.
Example 3 may include to enumerate all authentication flows that can lead to being admitted to the system so that the security strength of these flows can be compared.
Example 4 may include to identify all of the factors in the authentication flows and stack-rank the factors from “weakest”to “strongest”.
Example 5 may include to combine the risk due to the factors in each flow to produce the aggregate risk for each flow, and then stack-rank the flows from “weakest” to “strongest”.
Example 6 may include to display the various flows through the system from an unauthenticated to authenticated user in the form of a “subway map”of flows.
Example 7 may include to display a summary of aggregate risks across analyzed policies.
Example 8 may include to detect and notify administrators of other security issues besides authentication factors, such as “ghost” (inactive) users, dead assets (policy rules, groups, apps) that are no longer in use, inactive SSO API keys, and inappropriately long session timers.
Example 9 may include to pull public breach-event data from sources such as Breach-hq.com that announce, for instance, users were compromised by phishing SMS, and post timely warnings into our user interface saying “FOO-company was recently compromised via phishable SMS” next to the report on how many phishable SMS users are in the present deployment.
Example 10 may include to use dynamic monitoring to measure how often each factor is used in practice, and suggest disabling factors that are never used, to enhance overall security.
Example 11 may include may to identify flows that are single-factor, because they are higher risk, and violate various multi-factor authentication (MFA) requirements imposed by governments, corporate policies, and cyber-insurance vendors.
For example 12, many enterprises use “machine” accounts for automation and services, and it often matters that machine accounts be treated differently. We can detect machine accounts by inspecting directory information for attributes associated with humans, such as personal phone number, name of manager, salary, etc. that machine accounts tend to not have.
Example 13 may include a method for analyzing access authentication risk, comprising retrieving configuration data for access authentication for a system, determining one or more authentication flows for accessing the system based at least in part on the configuration data, determining one or more risk levels associated with the one or more authentication flows, and generating a risk representation illustrating at least a portion of the one or more risk levels associated with the one or more authentication flows.
Example 14 may include the method of example 13, further comprising transforming the configuration data to a data format representation for risk analysis, wherein the one or more authentication flows and the one or more risk levels are determined using the data format representation.
Example 15 may include the method of example 14, wherein the configuration data is first configuration data, wherein the first configuration data corresponds to a first authentication product, and wherein the method further comprises generating second configuration data based at least in part on the data format representation, the second configuration data corresponding to a second authentication product.
Example 16 may include the method of example 13, wherein determining the one or more risk levels associated with the one or more authentication flows includes determining one or more risks levels for one or more authentication factors within the one or more authentication flows.
Example 17 may include the method of example 16, further comprising identifying an authentication flow from the one or more authentication flows, determining a portion of the one or more authentication factors corresponding to the authentication flow, and determining a portion of the one or more risk levels corresponding to the portion of the one or more authentication factors, wherein the risk representation includes a visual representation of the one or more authentication flows, and wherein the visual representation illustrates the authentication flow with the portion of the one or more authentication factors and the portion of the one or more risk levels with the portion of the one or more authentication factors.
Example 18 may include the method of example 16, further comprising determining a portion of the one or more risk levels corresponding to an authentication flow of the one or more authentication flows, and generating an aggregate risk for the authentication flow based at least in part on the portion of the one or more risk levels, wherein the risk representation illustrates the aggregate risk for the authentication flow.
Example 19 may include the method of example 13, further comprising determining one or more authentication factors corresponding to the one or more authentication flows, and determining usage statistics for the one or more authentication factors, wherein the risk representation indicates at least a portion of the usage statistics for the one or more authentication factors.
Example 20 may include the method of example 19, further comprising identifying a portion of the one or more authentication factors that have not been used within a threshold time period based at least in part on the usage statistics, wherein the risk representation includes a suggestion to disable the portion of the one or more authentication factors or to disable a portion of the one or more authentication flows that include at least one authentication factor within the portion of the one or more authentication factors.
Example 21 may include the method of example 13, further comprising determining a portion of the one or more authentication flows that include a single authentication factor, wherein the risk representation indicates the portion of the one or more authentication flows that include a single authentication factor, and wherein the risk representation indicates the portion of the one or more authentication flows are high risk based at least in part on the portion of the one or more authentication flows including a single authentication factor.
Example 22 may include the method of example 13, wherein the configuration data is first configuration data, wherein the first configuration data corresponds to a first product, and wherein the method further comprises retrieving second configuration data corresponding to a second product, wherein the one or more risk levels are determined based at least in part on aggregating information from the first configuration data and the second configuration data.
Example 23 may include the method of example 13, further comprising determining one or more products that are of current interest, wherein the configuration data corresponds to the one or more products, and wherein the configuration data is retrieved based at least in part on determining the one or more products are of current interest.
Example 24 may include the method of example 13, wherein the configuration data is first configuration data, wherein the first configuration data corresponds to a first product, and wherein the method further comprises retrieving second configuration data corresponding to a second product for access authentication for the system, and updating the risk representation based at least in part on integration of information determined from the second configuration data.
Example 25 may include the method of example 13, wherein the configuration data is first configuration data, wherein the first configuration data corresponds to a first product, and wherein the method further comprises retrieving second configuration data corresponding to a second product for access authentication for the system, determining characteristics supported by the first product and not supported by the second product, and setting characteristic values corresponding to the characteristics for the second product to blank, wherein the one or more risk levels are determined with the characteristic values set to blank.
Example 26 may include the method of example 13, wherein the configuration data is first configuration data, wherein the first configuration data corresponds to a first time, and wherein the method further comprises determining a first value for a characteristic at the first time based at least in part on the first configuration data, retrieving second configuration data corresponding to a second time, determining a second value for the characteristic at the second time based at least in part on the second configuration data, and generating a second risk representation illustrating the first value at the first time and the second value at the second time for the characteristic.
Example 27 may include the method of example 13, wherein the system corresponds to an enterprise, wherein the configuration data is first configuration data for accessing the system of the enterprise, wherein the one or more risk levels are first one or more risk levels, and wherein the method further comprises retrieving second configuration data for accessing the system of the enterprise, determining second one or more risk levels associated with the one or more authentication flows based at least in part on the second configuration data, and generating a total risk score by aggregating the first one or more risk levels and the second one or more risk levels.
Example 28 may include the method of example 27, wherein aggregating the first one or more risk levels and the second one or more risk levels include averaging the first one or more risk levels and the second one or more risk levels, determining a geometric mean of the first one or more risk levels and the second one or more risk levels, or summing the first one or more risk levels and the second one or more risk levels.
Example 29 may include the method of example 13, wherein the configuration data corresponds to a first product, wherein the one or more risk levels are first one or more risk levels, and wherein the method further comprises generating alternate configuration data corresponding to a second product based at least in part on the configuration data, determining second one or more risk levels associated with the one or more authentication flows based at least in part on the alternate configuration data, and generating a second risk representation illustrating the first one or more risk levels associated with the first product and the second one or more risk levels associated with the second product.
Example 30 may include the method of example 13, further comprising determining one or more accounts corresponding to the one or more risk levels, determining privilege levels corresponding to the one or more accounts, and determining a portion of the one or more accounts associated with high risk levels and high privileged levels, wherein the risk representation further illustrates the portion of the one or more accounts as posing an elevated risk.
Example 31 may include the method of example 13, further comprising determining one or more accounts corresponding to the configuration data that have not been utilized for accessing the system within a threshold time period, wherein the risk representation further illustrates the one or more accounts as stale accounts.
Example 32 may include the method of example 31, further comprising disabling the one or more accounts to reduce an attack surface for accessing the system.
Example 33 may include the method of example 13, further comprising identifying breach event data, and determining an authentication factor included in the one or more authentication flows corresponding to the breach event data, wherein the risk representation indicates the breach event data with the authentication factor.
Example 34 may include the method of example 13, further comprising retrieving account information associated with the system, determining one or more accounts available to access the system based at least in part on the account information, determining access history for the one or more accounts based at least in part on the account information, and determining a portion of the one or more accounts have not accessed the system within a threshold amount of time, wherein the risk representation indicates the portion of the one or more accounts.
Example 35 may include the method of example 13, further comprising retrieving account information associated with the system, and determining one or more accounts with authentication factor limitation for accessing the system, wherein the risk representation indicates the one or more accounts with authentication factor limitation.
Example 36 may include the method of example 13, further comprising determining one or more access characteristics related to access provision for the system based at least in part on the configuration data, and identifying a portion of the one or more access characteristics associated with high risk access activities, wherein the risk representation indicates the portion of the one or more access characteristics.
Example 37 may include the method of example 36, wherein the high risk access activities include session timers that exceed a threshold time, or improper inactive key authentication.
Example 38 may include a method for presenting a risk representation of access authentication for a system, comprising retrieving configuration data for access authentication for the system, transforming the configuration data to a data format representation, and generating the risk representation based at least in part on the data format representation, the risk representation illustrating one or more risk levels for authentication flows for accessing the system.
Example 39 may include the method of example 38, wherein the configuration data is first configuration data, wherein the first configuration data corresponds to a first authentication product, wherein the one or more risk levels are first one or more risk levels corresponding to the first authentication product, and wherein the method further comprises determining second one or more risk levels corresponding to a second authentication product available for the system, and generating second configuration data corresponding to the second authentication product based at least in part on the data format representation, the second configuration data to be utilized for access authentication for the system.
Example 40 may include the method of example 38, further comprising determining one or more authentication flows for the accessing the system, and determining one or more aggregate risk levels for each of the one or more authentication flows, wherein the risk representation indicates the one or more aggregate risk levels for each of the one or more authentication flows.
Example 41 may include the method of example 38, further comprising determining a first authentication factor associated with an authentication flow for accessing the system, determining a second authentication factor associated with the authentication flow, determining a first risk level for the first authentication factor, and determining a second risk level for the second authentication factor, wherein the risk representation indicates the authentication flow with first risk level indicated with the first authentication factor and the second risk level indicated with the second authentication factor.
Example 42 may include a method for analyzing one or more authentication operations for a system, comprising identifying configuration data indicating the one or more authentication operations, determining one or more risk levels for the one or more authentication operations, and generating a risk representation that indicates the one or more risk levels for the one or more authentication operations.
Example 43 may include the method of example 42, further comprising transforming the configuration data to a data format representation, and determining the one or more authentication operations based at least in part on the data format representation, the one or more authentication operations including one or more authentication factors.
Example 44 may include the method of example 42, further comprising determining one or more authentication flows for accessing the system, and determining one or more aggregate risk levels for the one or more authentication flows based at least in part on the one or more risk levels for the one or more authentication operations, wherein the risk representation indicates the one or more authentication flows with the one or more aggregate risk levels.
Example 45 may include an apparatus comprising means to perform one or more elements of a method described in or related to any of examples 13-44, or any other method or process described herein.
Example 46 may include one or more non-transitory computer-readable media comprising instructions to cause an electronic device, upon execution of the instructions by one or more processors of the electronic device, to perform one or more elements of a method described in or related to any of examples 13-44, or any other method or process described herein.
Example 47 may include an apparatus comprising logic, modules, or circuitry to perform one or more elements of a method described in or related to any of examples 13-44, or any other method or process described herein.
Example 48 may include a method, technique, or process as described in or related to any of examples 13-44, or portions or parts thereof.
Example 49 may include an apparatus comprising: one or more processors and one or more computer-readable media comprising instructions that, when executed by the one or more processors, cause the one or more processors to perform the method, techniques, or process as described in or related to any of examples 13-44, or portions thereof.
Example 50 may include a signal as described in or related to any of examples 13-44, or portions or parts thereof.
Example 51 may include a datagram, information element, packet, frame, segment, PDU, or message as described in or related to any of examples 13-44, or portions or parts thereof, or otherwise described in the present disclosure.
Example 52 may include a signal encoded with data as described in or related to any of examples 13-44, or portions or parts thereof, or otherwise described in the present disclosure.
Example 53 may include a signal encoded with a datagram, IE, packet, frame, segment, PDU, or message as described in or related to any of examples 13-44, or portions or parts thereof, or otherwise described in the present disclosure.
Example 54 may include an electromagnetic signal carrying computer-readable instructions, wherein execution of the computer-readable instructions by one or more processors is to cause the one or more processors to perform the method, techniques, or process as described in or related to any of examples 13-44, or portions thereof.
Example 55 may include a computer program comprising instructions, wherein execution of the program by a processing element is to cause the processing element to carry out the method, techniques, or process as described in or related to any of examples 13-44, or portions thereof.
Example 56 may include a signal in a wireless network as shown and described herein.
Example 57 may include a method of communicating in a wireless network as shown and described herein.
Example 58 may include a system for providing wireless communication as shown and described herein.
Example 59 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

What is claimed is:

1. A method for analyzing access authentication risk, comprising:
retrieving configuration data for access authentication for a system;
determining one or more authentication flows for accessing the system based at least in part on the configuration data;
determining one or more risk levels associated with the one or more authentication flows; and
generating a risk representation illustrating at least a portion of the one or more risk levels associated with the one or more authentication flows.

2. The method of claim 1, further comprising:
transforming the configuration data to a data format representation for risk analysis, wherein the one or more authentication flows and the one or more risk levels are determined using the data format representation.

3. The method of claim 2, wherein the configuration data is first configuration data, wherein the first configuration data corresponds to a first authentication product, and wherein the method further comprises:
generating second configuration data based at least in part on the data format representation, the second configuration data corresponding to a second authentication product.

4. The method of claim 1, wherein determining the one or more risk levels associated with the one or more authentication flows includes determining one or more risks levels for one or more authentication factors within the one or more authentication flows.

5. The method of claim 4, further comprising:
identifying an authentication flow from the one or more authentication flows;
determining a portion of the one or more authentication factors corresponding to the authentication flow; and
determining a portion of the one or more risk levels corresponding to the portion of the one or more authentication factors, wherein the risk representation includes a visual representation of the one or more authentication flows, and wherein the visual representation illustrates the authentication flow with the portion of the one or more authentication factors and the portion of the one or more risk levels with the portion of the one or more authentication factors.

6. The method of claim 4, further comprising:
determining a portion of the one or more risk levels corresponding to an authentication flow of the one or more authentication flows; and
generating an aggregate risk for the authentication flow based at least in part on the portion of the one or more risk levels, wherein the risk representation illustrates the aggregate risk for the authentication flow.

7. The method of claim 1, further comprising:
determining one or more authentication factors corresponding to the one or more authentication flows; and
determining usage statistics for the one or more authentication factors, wherein the risk representation indicates at least a portion of the usage statistics for the one or more authentication factors.

8. The method of claim 7, further comprising:
identifying a portion of the one or more authentication factors that have not been used within a threshold time period based at least in part on the usage statistics, wherein the risk representation includes a suggestion to disable the portion of the one or more authentication factors or to disable a portion of the one or more authentication flows that include at least one authentication factor within the portion of the one or more authentication factors.

9. The method of claim 1, further comprising:
determining a portion of the one or more authentication flows that include a single authentication factor, wherein the risk representation indicates the portion of the one or more authentication flows that include a single authentication factor, and wherein the risk representation indicates the portion of the one or more authentication flows are high risk based at least in part on the portion of the one or more authentication flows including a single authentication factor.

10. The method of claim 1, wherein the configuration data is first configuration data, wherein the first configuration data corresponds to a first product, and wherein the method further comprises:
retrieving second configuration data corresponding to a second product, wherein the one or more risk levels are determined based at least in part on aggregating information from the first configuration data and the second configuration data.

11. The method of claim 1, further comprising:
determining one or more products that are of current interest, wherein the configuration data corresponds to the one or more products, and wherein the configuration data is retrieved based at least in part on determining the one or more products are of current interest.

12. The method of claim 1, wherein the configuration data is first configuration data, wherein the first configuration data corresponds to a first product, and wherein the method further comprises:
retrieving second configuration data corresponding to a second product for access authentication for the system; and
updating the risk representation based at least in part on integration of information determined from the second configuration data.

13. The method of claim 1, wherein the configuration data is first configuration data, wherein the first configuration data corresponds to a first product, and wherein the method further comprises:
retrieving second configuration data corresponding to a second product for access authentication for the system;
determining characteristics supported by the first product and not supported by the second product; and
setting characteristic values corresponding to the characteristics for the second product to blank, wherein the one or more risk levels are determined with the characteristic values set to blank.

14. The method of claim 1, wherein the configuration data is first configuration data, wherein the first configuration data corresponds to a first time, and wherein the method further comprises:
determining a first value for a characteristic at the first time based at least in part on the first configuration data;
retrieving second configuration data corresponding to a second time;
determining a second value for the characteristic at the second time based at least in part on the second configuration data; and
generating a second risk representation illustrating the first value at the first time and the second value at the second time for the characteristic.

15. The method of claim 1, wherein the system corresponds to an enterprise, wherein the configuration data is first configuration data for accessing the system of the enterprise, wherein the one or more risk levels are first one or more risk levels, and wherein the method further comprises:
retrieving second configuration data for accessing the system of the enterprise;
determining second one or more risk levels associated with the one or more authentication flows based at least in part on the second configuration data; and
generating a total risk score by aggregating the first one or more risk levels and the second one or more risk levels.

16. The method of claim 15, wherein aggregating the first one or more risk levels and the second one or more risk levels include:
averaging the first one or more risk levels and the second one or more risk levels;
determining a geometric mean of the first one or more risk levels and the second one or more risk levels; or
summing the first one or more risk levels and the second one or more risk levels.

17. The method of claim 1, wherein the configuration data corresponds to a first product, wherein the one or more risk levels are first one or more risk levels, and wherein the method further comprises:
generating alternate configuration data corresponding to a second product based at least in part on the configuration data;
determining second one or more risk levels associated with the one or more authentication flows based at least in part on the alternate configuration data; and
generating a second risk representation illustrating the first one or more risk levels associated with the first product and the second one or more risk levels associated with the second product.

18. The method of claim 1, further comprising:
determining one or more accounts corresponding to the one or more risk levels;
determining privilege levels corresponding to the one or more accounts; and
determining a portion of the one or more accounts associated with high risk levels and high privileged levels, wherein the risk representation further illustrates the portion of the one or more accounts as posing an elevated risk.

19. The method of claim 1, further comprising:
determining one or more accounts corresponding to the configuration data that have not been utilized for accessing the system within a threshold time period, wherein the risk representation further illustrates the one or more accounts as stale accounts.

20. The method of claim 19, further comprising:
disabling the one or more accounts to reduce an attack surface for accessing the system.

21. The method of claim 1, further comprising:
identifying breach event data; and
determining an authentication factor included in the one or more authentication flows corresponding to the breach event data, wherein the risk representation indicates the breach event data with the authentication factor.

22. The method of claim 1, further comprising:
retrieving account information associated with the system;
determining one or more accounts available to access the system based at least in part on the account information;
determining access history for the one or more accounts based at least in part on the account information; and
determining a portion of the one or more accounts have not accessed the system within a threshold amount of time, wherein the risk representation indicates the portion of the one or more accounts.

23. The method of claim 1, further comprising:
retrieving account information associated with the system; and
determining one or more accounts with authentication factor limitation for accessing the system, wherein the risk representation indicates the one or more accounts with authentication factor limitation.

24. The method of claim 1, further comprising:
determining one or more access characteristics related to access provision for the system based at least in part on the configuration data; and
identifying a portion of the one or more access characteristics associated with high risk access activities, wherein the risk representation indicates the portion of the one or more access characteristics.

25. The method of claim 24, wherein the high risk access activities include:
session timers that exceed a threshold time; or
improper inactive key authentication.

26. One or more non-transitory computer-readable media having instructions stored thereon, wherein the instructions, when executed, cause an analysis system to:
retrieve configuration data for access authentication for a system;
transform the configuration data to a data format representation; and
generate a risk representation based at least in part on the data format representation, the risk representation illustrating one or more risk levels for authentication flows for accessing the system.

27. The one or more non-transitory computer-readable media of claim 26, wherein the configuration data is first configuration data, wherein the first configuration data corresponds to a first authentication product, wherein the one or more risk levels are first one or more risk levels corresponding to the first authentication product, and wherein the instructions, when executed, further cause the analysis system to:
determine second one or more risk levels corresponding to a second authentication product available for the system; and
generate second configuration data corresponding to the second authentication product based at least in part on the data format representation, the second configuration data to be utilized for access authentication for the system.

28. The one or more non-transitory computer-readable media of claim 26, wherein the instructions, when executed, further cause the analysis system to:
determine one or more authentication flows for the accessing the system; and
determine one or more aggregate risk levels for each of the one or more authentication flows, wherein the risk representation indicates the one or more aggregate risk levels for each of the one or more authentication flows.

29. The one or more non-transitory computer-readable media of claim 26, wherein the instructions, when executed, further cause the analysis system to:
determine a first authentication factor associated with an authentication flow for accessing the system;
determine a second authentication factor associated with the authentication flow;
determine a first risk level for the first authentication factor; and
determine a second risk level for the second authentication factor, wherein the risk representation indicates the authentication flow with first risk level indicated with the first authentication factor and the second risk level indicated with the second authentication factor.

30. A method for analyzing one or more authentication operations for a system, comprising:
identifying configuration data indicating the one or more authentication operations;
determining one or more risk levels for the one or more authentication operations; and
generating a risk representation that indicates the one or more risk levels for the one or more authentication operations.

31. The method of claim 30, further comprising:
transforming the configuration data to a data format representation; and
determining the one or more authentication operations based at least in part on the data format representation, the one or more authentication operations including one or more authentication factors.

32. The method of claim 30, further comprising:
determining one or more authentication flows for accessing the system; and
determining one or more aggregate risk levels for the one or more authentication flows based at least in part on the one or more risk levels for the one or more authentication operations, wherein the risk representation indicates the one or more authentication flows with the one or more aggregate risk levels.
